(19) United States
(12) Patent Application Publication
(10) Pub. No.: US 2026/0300037 A1
(43) Pub. Date: Oct. 1, 2026

(54) FIBER-OPTIC CABLE BUNDLING FOR INTERCONNECTING DATACENTERS

(71) Applicant: Quantum Loophole, Inc., Austin, TX (US)

(72) Inventors: Scott Noteboom, Austin, TX (US); Josh Snowhorn, Austin, TX (US); Richard Paul-Hus, Sebring, FL (US); Shane Canekeratne, Redwood City, CA (US)

(21) Appl. No.: 19/696,757

(22) Filed: Jun. 3, 2026

Related U.S. Application Data
(62) Division of application No. 18/249,958, filed on Apr. 20, 2023, now abandoned.

(30) Foreign Application Priority Data
Sep. 22, 2021 (WO) PCT/US2021/051440

(51) Int. Cl. G06F 9/50

(52) U.S. Cl. CPC G06F 9/5094; G06F 9/505

(57) ABSTRACT

Various embodiments of the present technology relate to systems and apparatuses for coupling high-count fiber-optic bundles. In an embodiment, a fiber-optic bundle coupling apparatus is provided. The apparatus includes a first coupling end configured to encapsulate a first fiber-optic bundle and a first sleeve disposed within the first coupling end. The apparatus further includes a second coupling end configured to encapsulate a second fiber-optic bundle and a second sleeve disposed within the second coupling end. A strand separator is positioned within the second coupling end and includes a plurality of openings corresponding to fiber-optic cables of the first fiber-optic bundle, each opening configured to receive a respective fiber-optic cable. The first and second fiber-optic bundles are spliced together, and the first coupling end and second coupling end are coupled via a locking mechanism to cover a spliced region of the fiber-optic bundles.

### RELATED APPLICATIONS

This application is a divisional of and claims priority to U.S. Non-Provisional Patent Application No. 18/249,958, filed on April 20, 2023, entitled "ORCHESTRATING DATACENTER WORKLOADS BASED ON ENERGY FORECASTS," and PCT Patent Application No. PCT/US21/51440, filed September 21, 2021, entitled "ORCHESTRATING DATACENTER WORKLOADS BASED ON ENERGY FORECASTS", which are both incorporated herein by reference in their entirety for all purposes.

### TECHNICAL FIELD

### BACKGROUND

Cloud computing, however, remains an expensive endeavor requiring large amounts of land, cable, time, and more. With respect to cabling for powering and routing data between datacenters and other systems, at present, there are no readily applicable solutions that can enable structured alignment and coupling of high-count fiber-optic bundles including at least tens of thousands of individual fiber-optic cables. Conventional solutions may include splicing techniques to connect a strand of fiber-optic cable to another strand of fiber-optic cable. However, such techniques fail to account for large bundles of cables underground or undersea that may span several miles.

### OVERVIEW

In various embodiments, the strand separator includes at least 100,000 openings corresponding to individual fiber-optic cables, such that each fiber-optic cable is positioned within a respective opening to maintain alignment of the fiber-optic cables during splicing. The fiber-optic bundles may be spliced together and enclosed by the coupling apparatus, which may further include a locking mechanism configured to couple the opposing coupling ends and cover spliced regions of the fiber-optic cables. In some embodiments, additional sealing elements including sleeves, O-rings, or injectable materials may be used to provide environmental protection to the spliced region.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the disclosure. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 illustrates an exemplary system architecture in which some embodiments of the present technology may be utilized;

FIG. 2 illustrates cross-section views of a fiber-optic communication bundle in accordance with some embodiments of the present technology;

FIGS. 3A, 3B, 3C, 3D, 3E, and 3F, illustrate a coupling apparatus and pull-plate apparatus for fiber-optic telecommunications bundles in accordance with some embodiments of the present technology;

FIGS. 4A, 4B, 4C, and 4D,illustrate a series of steps to use a coupling apparatus with a fiber-optic communication bundle in accordance with some embodiments of the present technology;

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to systems, methods, and apparatuses for coupling and bundling large pluralities of fiber-optic cables between interconnected datacenters. In some embodiments, multiple datacenter sites or campuses may be located geographically and physically close to each other, wired together by over a hundred thousand strands of fiber-optic communication cables. Fiber interconnection at each campus head end may be achieved using robotic cross-connect platforms that may allow for simultaneous moves and adds for fiber cross-connects within a five-minute window. Such robotic cross-connect platforms may include a multiplexer or switching unit that may uncouple one bundle of fiber-optic cables or one strand of cable of a bundle to redirect data from one datacenter to another, for example. This may occur based on power or capacity limitations at one data center to allow data transfer to another to complete a job. A fiber-optic distance window tolerance of 1 to 65 miles is maintained to reduce optical latency and allow the use of low-cost optics for telecommunications transmission. Each campus may be fed by grid power paths or renewable energy sources that are unique to that campus to help prevent the failure of more than one campus from the same power line outage.

In an embodiment, a fiber-optic bundle coupling apparatus is provided. The apparatus comprises a first coupling end configured to encapsulate a first fiber-optic bundle of at least 100,000 fiber-optic cables and a first rubber sleeve positioned within the first coupling end to surround the first fiber-optic bundle. The apparatus further comprises a second coupling end configured to encapsulate a second fiber-optic bundle of at least 100,000 fiber-optic cables and a second rubber sleeve positioned within the second coupling end to surround the second fiber-optic bundle. A strand separator is positioned within an end portion of the second coupling end facing the first coupling end, the strand separator comprising at least 100,000 openings corresponding to the fiber-optic cables of the first fiber-optic bundle, wherein each fiber-optic cable is insertable into a respective opening to maintain positional organization. The first and second fiber-optic bundles may be spliced together, and the first coupling end and second coupling end may be coupled using a locking mechanism to cover a spliced region.

In another embodiment, a fiber-optic bundle including a coupling apparatus and a pull plate is provided. The fiber-optic bundle coupling apparatus comprises a first coupling end, wherein the first coupling end encapsulates a first fiber-optic bundle of at least 100,000 fiber-optic cables inserted into a strand separator and surrounded by a first rubber sleeve. The apparatus also comprises a second coupling end, wherein the second coupling end encapsulates a second fiber-optic bundle of at least 100,000 fiber-optic cables surrounded by a second rubber sleeve. And the apparatus further comprises a locking mechanism, wherein the first fiber-optic bundle and the second fiber-optic bundle are spliced together, and the first coupling end and the second coupling end are mated to cover spliced areas of the first and second fiber-optic bundles. The pull plate includes a plurality of cable hooks and a pull hook; the pull plate coupled to the single fiber-optic bundle for pulling the single fiber-optic bundle.

In yet another embodiment, a method is provided. The method includes inserting a first fiber-optic bundle of at least 100,000 fiber-optic cables surrounded by a first rubber sleeve into a strand separator, coupling the first fiber-optic bundle to a second fiber-optic bundle of at least 100,000 fiber-optic cables surrounded by a second rubber sleeve by at least splicing the first fiber-optic bundle and the second fiber-optic bundle together to create a single fiber-optic bundle of at least 100,000 fiber-optic cables, and coupling swivel heads onto the at least 100,000 fiber-optic cables of the single fiber-optic bundle.

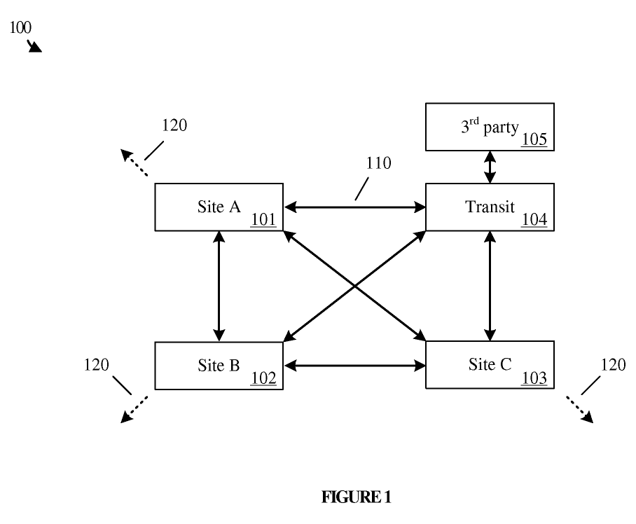

Turning now to the Figures, FIG. 1 illustrates an exemplary operational environment 100 in which some embodiments of the present technology may be utilized. FIG. 1 demonstrates operational environment 100 which further includes site A 101, site B 102, site C 103, transit 104, 3^{rd} party 105, fiber-optic bundles 110, and telecommunications lines 120. Operational environment 100 may be comprised of a mix of hardware, software, firmware, vaporware, and the like. In the illustrated FIG. 1, interconnected multi-site datacenters use grid energy to operate while data-loading between each other by using fiber-optic cables that connect each site together. Each site may securely upload data to a cloud or other external network to communicate with other datacenters or third party applications.

In accordance with some embodiments, site A 101, site B 102, and site C 103 comprise datacenters capable of performing computing jobs. Each site may obtain power from a grid or renewable energy sources independently of one another. For example, site A 101 may connect to a local electric grid, site B 102 may be powered by solar cells, and site C 103 may be powered by wind turbines. Alternatively, each site of the three sites may utilize grid power but may use unique grid power paths as another way to prevent failure of more than one site from the same power line outage. The benefit of having independent sources of power helps mitigate power failures, so that one or more sites may continue operating during a power failure of one site’s energy source. Transmission scale grid power may add uptime resiliency which may negate the need for traditional datacenter backup generators as well.

As illustrated in FIG. 1, each of site A 101, site B 102, and site C 103, along with transit 104 and 3^{rd} party 105, may be interconnected by fiber-optic bundles 110. Fiber-optic bundles 110 comprise at least 100,000 strands of fiber-optic cables that may be spliced or coupled together. Each site may be interconnected by fiber-optic bundles 110 from one to 65 miles apart to help reduce latency and allow for low-cost optics for telecommunications transmissions. At an interconnection point at transit 104, a point of presence (POP) may exist in a single or dual configuration which allows fiber-optic bundles 110 to be terminated in an existing telecommunications market for a handoff of traffic from each datacenter site to other parties. Transit 104 may serve as an ingress/egress into and out of each site’s network or a 3^{rd} party 105 network and may operate as a cloud network.

At each site, fiber-optic bundles 110 may be interconnected at each campus or site using robotic cross-connect platforms to allow for simultaneous moves and adds for fiber-optic connections within a five-minute window. The robotic cross-connect platforms may comprise a multiplexer, switching unit, or the like that allows fiber-optic bundles 110 to connect one site to another site for data transfer or another telecommunications transmission. By way of example, site A 101 may have an increased demand for computing jobs, while site C 103 may be underutilized. A switching unit may then connect fiber-optic bundles 110 from site A 101 to connect to site C 103 to reroute data from one to the other, respectively. As another example, site A 101 may have high energy costs to perform a job, while site C 103 has lower energy costs to complete the same job. Thus, a job may be rerouted to save costs and time using switching unit or robotic cross-connect platforms.

From each site of the three sites, telecommunications lines 120 may allow the passage of traffic to other markets. Some telecommunications lines 120 may be undersea cable systems, depending on geographic location, to provide data to tenants of the datacenter campuses.

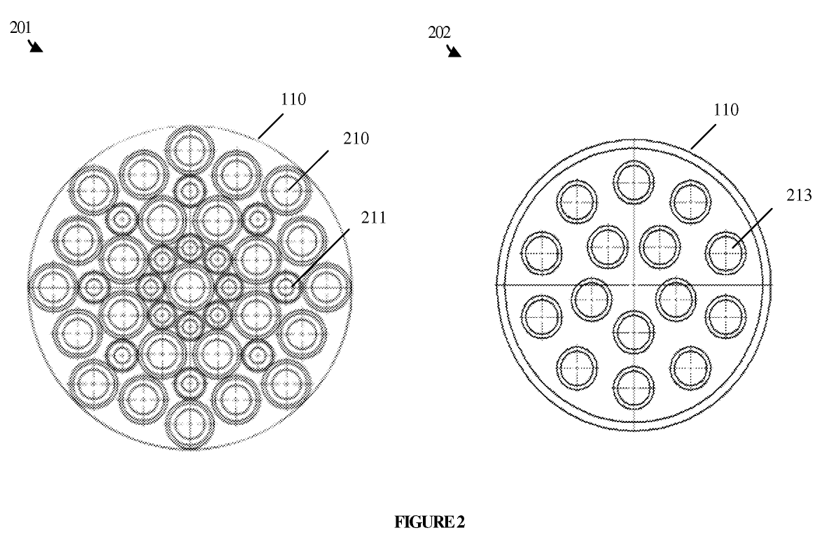

Moving to FIG. 2, FIG. 2 illustrates cross-section views of a fiber-optic communication bundle in accordance with some embodiments of the present technology. FIG. 2 includes aspects 201 and 202. Both aspects 201 and 202 show fiber-optic bundles 110 of FIG. 1, which may comprise at least 100,000 strands of fiber-optic cables. Inside a conduit housing the bundle, fiber-optic cables of varying diameter may be used to accomplish system objectives.

As demonstrated in aspect 201, fiber-optic bundles 110 may use a fiber-optic strand 210 and a fiber-optic strand 211 in various patterns and sizes to maximize space. The pattern used may resemble for a 41-way pattern of fiber-optic cable bundling. Using various sizes of strands may allow for a minimally sized conduit to house the bundle to lessen the environmental impact when installing the conduit underground or undersea, for example.

Similarly, aspect 202 demonstrates a cross-section view of fiber-optic bundles 110 that may use a single size fiber optic strand 213. In some embodiments, a 5.10 pattern may be used to accomplish such a pattern of fiber-optic cable bundling.

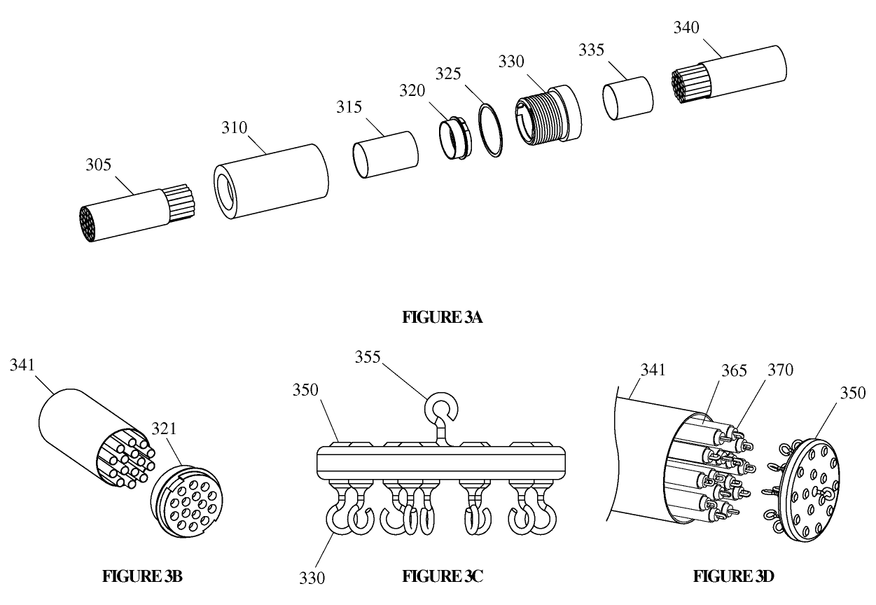

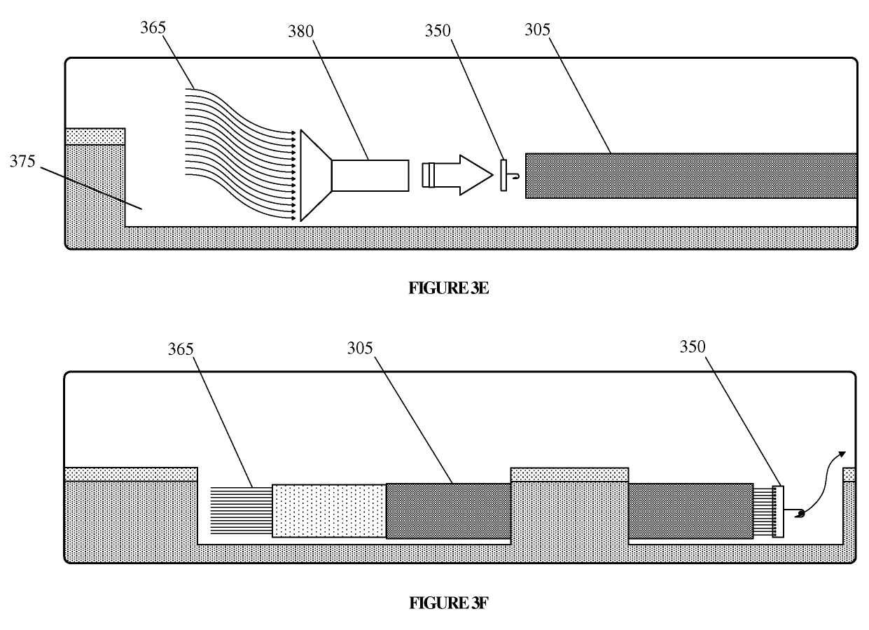

Next, FIGS. 3A, 3B, 3C, 3D, 3E, and 3F, illustrate a coupling apparatus and pull-plate apparatus for fiber-optic telecommunications bundles in accordance with some embodiments of the present technology.

FIG. 3A includes conduit A 305, coupling end A 310, rubber sleeve A 315, 41-way hybrid insert 320, rubber O-ring 325, coupling end B 330, rubber sleeve B 335, and conduit B 340. The coupling apparatus or device exemplified in FIG. 3A may be employed to interconnect datacenter campuses and/or connect fiber-optic bundles together at various points, among other uses.

In some embodiments, the strand separator comprises a plate or insert including a plurality of discrete openings corresponding to individual fiber-optic cables of a fiber-optic bundle. Each fiber-optic cable of the fiber-optic bundle may be inserted into a respective opening of the strand separator such that the fiber-optic cables are individually aligned and maintained in a positional arrangement during splicing. In some embodiments, the openings correspond to individual fiber-optic cables of a first fiber-optic bundle that are to be spliced with a second fiber-optic bundle.

In some embodiments, the strand separator is positioned within a coupling end such that the openings are oriented toward an opposing fiber-optic bundle, thereby facilitating orderly insertion and alignment of individual fiber-optic cables prior to splicing.

In some embodiments, the strand separator comprises a structured insert including a plurality of discrete openings corresponding to individual fiber-optic cables of a fiber-optic bundle. Each fiber-optic cable may be inserted into a respective opening such that the fiber-optic cables are maintained in a one-to-one positional arrangement. This arrangement may maintain relative positioning of the fiber-optic cables during insertion and splicing operations to facilitate orderly alignment of the fiber-optic cables.

In some embodiments, the strand separator is positioned within a coupling end at or near an interface between opposing fiber-optic bundles. The openings of the strand separator may be oriented toward an opposing fiber-optic bundle to facilitate insertion of fiber-optic cables and alignment of the fiber-optic cables prior to and during splicing.

In some embodiments, the strand separator comprises a rigid or semi-rigid insert including a predefined arrangement of openings. The rigid or semi-rigid structure may maintain spatial positioning of the openings during handling and assembly to preserve alignment of the fiber-optic cables. In some embodiments, individual fiber-optic cables may be guided into respective openings of a strand separator prior to insertion into a conduit. The plurality of openings may be arranged to accommodate high-density packing of fiber-optic cables within the strand separator.

In some embodiments, fiber-optic cables of a first fiber-optic bundle are inserted into the openings of the strand separator prior to splicing with corresponding fiber-optic cables of a second fiber-optic bundle. The strand separator may maintain positional alignment of the fiber-optic cables during the splicing process.

In various embodiments, conduit A 305 may comprise a fiber-optic cable bundle of 100,000 strands of cable, like fiber-optic bundles 110 as illustrated in FIG. 1. Rubber sleeve A 315 may be inserted into coupling end A 310, and subsequently, conduit A 305 may be inserted into coupling end A 310 thereafter. Meanwhile, rubber sleeve B 335 may be inserted into coupling end B 330, rubber O-ring 325 may be placed over the grooves of coupling end B 330, and 41-way hybrid insert 320 may be inserted on the other end of coupling end B 330. Then, conduit B 340 may be inserted into coupling end B 330. Both conduit A 305 and conduit B 340 each have part of the coupling apparatus covering part of their respective fiber-optic bundle end.

Finally, the ends of conduit A 305 and conduit B 340 may be spliced together using one or more splicing methods. By way of example, given the large quantity of stands of fiber-optic cables in each bundle that may be spliced together, the conduits may be fusion spliced together by a machine. In other embodiments, the bundles may be spliced together using integrated robotics. In such examples, a large container may be used to house the spliced areas of bundles underground or above ground wherein robotics or other splicing machinery may be utilized to accomplish the splicing process.

Upon completion of the splicing process of conduit A 305 and conduit B 340, coupling end A 310 may be inserted, locked, screwed, twisted, mated, or the like into coupling end B 330 to ensure the coupling apparatus covers the spliced area of cables. Further, in some embodiments, an injectable resin or epoxy may be inserted into the coupling apparatus to ensure safety of the spliced cable bundles. Using such methods may also create air-tight, waterproof sections of spliced cables for protection from pollutants or water. Additionally, rubber O-ring 325 may provide additional safety from pollutants, air, or water.

In some embodiments, the first rubber sleeve, the second rubber sleeve, and the coupling between the coupling ends cooperate to form a sealed enclosure surrounding the spliced areas of the fiber-optic cables. The sealed enclosure may be configured to reduce ingress of contaminants, moisture, or air, and may be further enhanced using injectable materials or sealing elements.

FIG. 3B demonstrates a conduit C 341 and rubber sleeve C 321 that may be used in place of conduit A 305, conduit B 340, and rubber sleeve B 320. The other illustrated pieces of coupling apparatus may be used interchangeably. Conduit C 341 and rubber sleeve 321 embody a different fiber-optic cable bundle that may use a 5.10 cable pattern for varying uses.

FIG. 3C illustrates a view of a pull-plate apparatus that can be used to pull fiber-optic cables or conduits simultaneously. FIG. 3C includes pull plate 350, pull hook 355, and cable hook 360. Pull plate 350 is designed to include a number of cable hooks 360 equivalent to the number of fiber-optic cables that need to be pulled through a conduit, pipe, or the like. In some embodiments, a swivel head or other hooking mechanism is inserted into a conduit to be attached to cable hook 360. Pull plate 350 also includes one or more of pull hook 355 used to pull on the other side of pull plate 350 and withstand a large weight of cables. In order to perform the pulling of cables, pull hook 355 may be attached to a winch or other mechanical device.

FIG. 3D illustrates an isometric view of a pull-plate apparatus and a conduit of fiber-optic cables. FIG. 3D includes conduit C 341, duct 365, swivel head 370, and pull plate 350. As shown, conduit 341 includes a number of duct 365 each comprising fiber-optic cables to be used in accordance with the present disclosure. Swivel head 370 is placed in duct 365 to pull duct 365 through conduit C 341. When swivel head 370 is placed in duct 365, pull plate 350 may hook onto each of swivel head 370 so that the pulling of each duct 365 is completed simultaneously, at the same speed.

FIGS. 3E and 3F illustrate an exemplary sequence of pulling ducts of fiber-optic cables through a conduit underground in accordance with some embodiments of the present disclosure. FIG. 3E includes trench 375, duct 365, duct organizer 380, pull plate 350, and conduit A 305. Trench 375 resembles a piece of land that a conduit is placed in to run the telecommunications lines or cables. Once placed in trench 375, duct 365 is run through duct organizer 380, which functions to organize the fiber-optic cables so that they are organized in a pattern such as one demonstrated in FIG. 2A or 2B, for example. In various embodiments, duct organizer 380 distributes each duct 365 into a 5/10 pattern. In other embodiments, duct organizer 380 distributes each duct 365 into a 41-way pattern, or some other pattern. After organizing the individual ducts, swivel heads are placed on each duct 365 so that pull plate 350 can be attached to duct 365 before entering conduit A 305. Then, as shown in FIG. 3F, each of duct 365 is pulled simultaneously by pull plate 350 through conduit A 305. In some embodiments, pull plate 350 is attached to a winch or some other mechanical device to pull each duct 365 at the same speed and time.

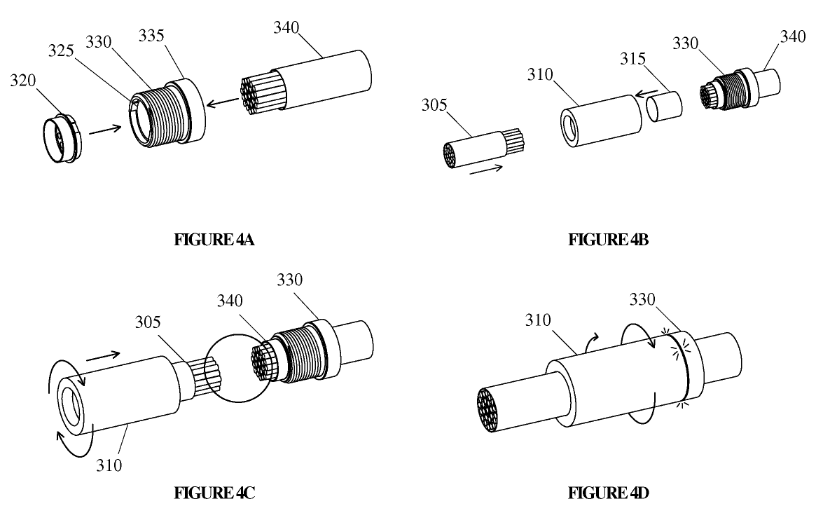

FIGS. 4A, 4B, 4C, and 4D, illustrate a series of steps to use a coupling apparatus with a fiber-optic cable bundle in accordance with some embodiments of the present technology. FIGS. 4A, 4B, 4C, and 4D,exemplify the coupling apparatus demonstrated in FIG. 3 that includes conduit A 305, coupling end A 310, rubber sleeve A 315, 41-way hybrid insert 320, rubber O-ring 325, coupling end B 330, rubber sleeve B 335, and conduit B 340. In some embodiments, multiple coupling apparatuses including respective strand separators may be deployed along a length of a fiber-optic bundle to facilitate sectional splicing and protection.

As demonstrated in FIG. 4A, both 41-way hybrid insert 320 and conduit B 340 may be inserted into coupling end B 330. Coupling B 330 may comprise inserted rubber sleeve B 335 and rubber O-ring 325. Likewise, as demonstrated in FIG. 4B, conduit A 305 and rubber sleeve A 315 may be inserted into coupling end A 310. Next, in FIG. 4C, conduit A 305 and conduit B 340 may be spliced together by one or more splicing methods to create a single conduit of fiber-optic cables. Finally, in FIG. 4D, coupling end A 310 and coupling end B 330 may be connected together or inserted one into the other to form the coupling apparatus. The coupling apparatus may be twisted to lock in place or use a similar locking mechanism to prevent the bundles from coming apart and to mitigate any entry of pollutants, air, or water into the spliced area. The coupling apparatus may be used as many times as necessary along the fiber-optic cable bundles to ensure interconnection between campuses and third parties, in accordance with embodiments of the present disclosure.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to.” As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A fiber-optic bundle coupling apparatus comprising:
a first coupling end configured to encapsulate a first fiber-optic bundle of at least 100,000 fiber-optic cables;
a first rubber sleeve configured to be inserted into the first coupling end and to surround the first fiber-optic bundle;
a second coupling end configured to encapsulate a second fiber-optic bundle of at least 100,000 fiber-optic cables to be spliced together with the at least 100,000 fiber-optic cables of the first fiber-optic bundle;
a second rubber sleeve configured to be inserted into the second coupling end and to surround the second fiber-optic bundle;
a strand separator configured to be inserted into an end portion of the second coupling end facing the first coupling end, the strand separator comprising at least 100,000 openings corresponding to the at least 100,000 fiber-optic cables of the first fiber-optic bundle, wherein each of the fiber-optic cables of the at least 100,000 fiber-optic cables is configured to be inserted into a respective opening of the at least 100,000 openings of the strand separator; and
a locking mechanism configured to couple the first coupling end and the second coupling end to cover spliced areas of the first and second fiber-optic bundles after the first and second fiber-optic bundles are spliced together.

2. The fiber-optic bundle coupling apparatus of claim 1, wherein the fiber-optic cable openings of the strand separator are organized in a 41-way pattern.

3. The fiber-optic bundle coupling apparatus of claim 1, wherein the fiber-optic cable openings of the strand separator are organized in a 5.10 pattern.

4. The fiber-optic bundle coupling apparatus of claim 1, wherein the locking mechanism comprises a threaded interface, a twist-lock interface, or a mating interface.

5. The fiber-optic bundle coupling apparatus of claim 1, further comprising an O-ring positioned between the first coupling end and the second coupling end.

6. The fiber-optic bundle coupling apparatus of claim 1, wherein the strand separator comprises a hybrid insert.

7. The fiber-optic bundle coupling apparatus of claim 1, wherein the first rubber sleeve and the second rubber sleeve are configured to compress around the respective fiber-optic bundles.

8. The fiber-optic bundle coupling apparatus of claim 1, further comprising an injectable resin or epoxy disposed within the coupling apparatus.

9. The fiber-optic bundle coupling apparatus of claim 1, wherein the first fiber-optic bundle and the second fiber-optic bundle are fusion spliced.

10. The fiber-optic bundle coupling apparatus of claim 1, wherein the first fiber-optic bundle and the second fiber-optic bundle are each disposed within a conduit.

11. A fiber-optic bundle comprising:
a first fiber-optic bundle of at least 100,000 fiber-optic cables;
a second fiber-optic bundle of at least 100,000 fiber-optic cables; and
a fiber-optic bundle coupling apparatus of claim 1 disposed between the first fiber-optic bundle and the second fiber-optic bundle,
wherein the first fiber-optic bundle and the second fiber-optic bundle are spliced to form the fiber-optic bundle.

12. The fiber-optic bundle of claim 11, further comprising an injectable resin or epoxy disposed within the coupling apparatus to create a waterproof seal.

13. The fiber-optic bundle of claim 11, further comprising a plurality of swivel heads, each swivel head coupled to a respective fiber-optic cable.

14. The fiber-optic bundle of claim 13, further comprising a pull plate comprising a plurality of cable hooks and a pull hook, wherein each cable hook is coupled to a respective swivel head.

15. The fiber-optic bundle of claim 14, wherein the fiber-optic bundle comprises a plurality of ducts of fiber-optic cables coupled to the pull plate.

16. The fiber-optic bundle of claim 11, wherein fiber-optic cables of at least one of the first fiber-optic bundle or the second fiber-optic bundle are arranged in a 41-way pattern.

17. The fiber-optic bundle of claim 11, wherein fiber-optic cables of at least one of the first fiber-optic bundle or the second fiber-optic bundle are arranged in a 5.10 pattern.

18. The fiber-optic bundle of claim 11, wherein the fiber-optic bundle is configured to interconnect datacenter sites separated by a distance between 1 mile and 65 miles.

19. The fiber-optic bundle of claim 11, wherein the fiber-optic bundle is configured to be terminated at a point of presence.

20. The fiber-optic bundle of claim 11, wherein the fiber-optic bundle is configured to interface with a robotic cross-connect platform to route data between datacenter sites.
